(19) United States
(12) Patent Application Publication
(10) Pub. No.: US 2025/0178438 A1
(43) Pub. Date: Jun. 5, 2025

(54) PROJECTION MANAGEMENT APPARATUS AND NON-TRANSITORY COMPUTER READABLE STORAGE MEDIUM

(71) Applicant: HONDA MOTOR CO., LTD., Tokyo (JP)

(72) Inventors: Koya SAITO, Tokyo (JP); Tatsumi SUZUKI, Saitama (JP); Ryotaro NISHIDA, Saitama (JP); Yoshikazu MATSUO, Tokyo (JP); Takafumi ENOMOTO, Tokyo (JP); Kenji OKUMA, Tokyo (JP)

(21) Appl. No.: 18/963,783

(22) Filed: Nov. 29, 2024

(30) Foreign Application Priority Data
Nov. 30, 2023 (JP) 2023-203109

(51) Int. Cl. B60K 35/28; B60K 35/80

(52) U.S. Cl. CPC B60K 35/28; B60K 35/80; B60K 2360/149; B60K 2360/176; B60K 2360/334

(57) ABSTRACT

The projection management apparatus includes a line-of-sight estimator, a position estimator, and a definer. The line-of-sight estimator estimates the line of sight of a person in a cabin of a vehicle. The position estimator estimates the position of the projector apparatus that is installed in the vehicle and projects an image in the cabin. The definer defines the projection direction of the projector apparatus using the line of sight and the position.

This application is based on and claims the benefit of priority from Japanese Patent Application No. 2023-203109, filed on Nov. 30, 2023, the content of which is incorporated herein by reference.

### BACKGROUND OF THE INVENTION

### Field of the Invention

The present invention relates to a projection management apparatus, and a non-transitory computer readable storage medium.

### Related Art

There is a technique that controls the projection position of a projector apparatus installed in a vehicle, depending on the state of a seat in the vehicle.
Patent Document 1: Japanese Unexamined Patent Application, Publication No. 2020-83204

### SUMMARY OF THE INVENTION

According to this technique, the position of the projector apparatus is fixed. Consequently, this technique cannot support a case where the position of the projector apparatus is indefinite. The case where the position of the projector apparatus is indefinite is, for example, a case where the projector apparatus is retrofit.

An object of an embodiment of the present invention is to provide a projection management apparatus and a non-transitory computer readable storage medium that can define a projection position easily visible to a viewer even if the position of the projector apparatus is indefinite.

The projection management apparatus in the embodiment includes a line-of-sight estimator, a position estimator, and a definer. The line-of-sight estimator estimates the line of sight of a person in a cabin of a vehicle. The position estimator estimates the position of the projector apparatus that is installed in the vehicle and projects an image in the cabin. The definer defines the projection direction of the projector apparatus using the line of sight and the position.

It is possible for the present invention to define the projection position easily visible to a viewer even if the position of the projector apparatus is indefinite.

### BRIEF DESCRIPTION OF THE DRAWINGS

FIG. 1 is a block diagram showing an example of main configurations of a projector system according to an embodiment and configuration elements included in this projector system; and

FIG. 2 is a flowchart showing an example of processes by a processor of a control apparatus in FIG. 1.

### DETAILED DESCRIPTION OF THE INVENTION

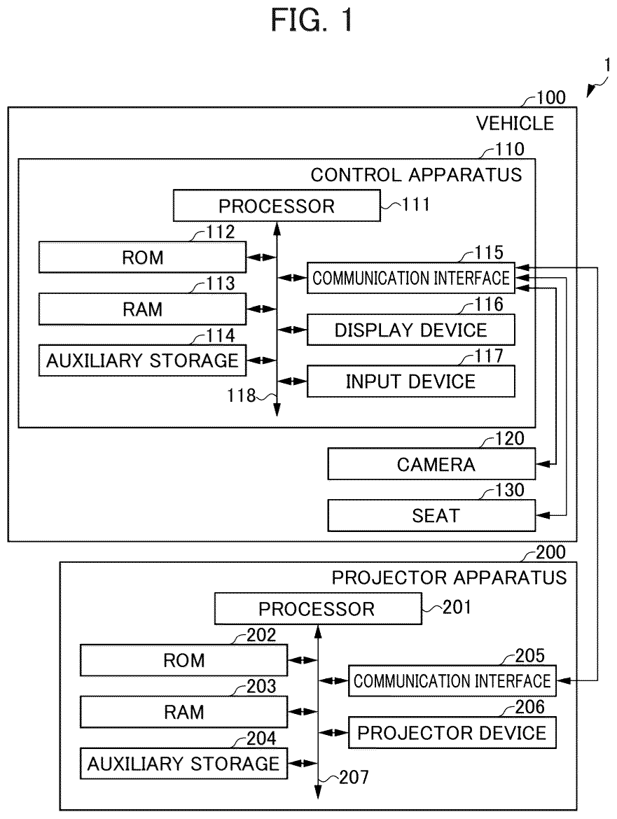

Hereinafter, a projector system according to an embodiment is described with reference to the drawings. Note that in the drawings used to describe the following embodiment, scales for the components may be changed as appropriate. In the drawings used to describe the following embodiment, components may be omitted for illustration purposes. In the drawings and this Specification, the same symbols indicate similar elements. FIG. 1 is a block diagram showing an example of main configurations of the projector system 1 according to the embodiment and configuration elements included in the projector system 1. Note that each configuration element in the apparatus may be embedded or external. The projector system 1 is a system that projects a video in a cabin of a vehicle 100. The projector system 1 is a system that defines the projection position of the projected image using the direction of eyes of a person in the cabin of the vehicle 100. The projector system 1 includes, for example, the vehicle 100, and a projector apparatus 200. Note that the projector system 1 may include some of these.

The vehicle 100 is, for example, an automobile. Any type of automobile is allowed. The vehicle 100 includes, for example, a control apparatus 110, a camera 120, and a seat 130. Note that the control apparatus 110 is not necessarily included in the vehicle 100.

The control apparatus 110 is an apparatus that can control the projector apparatus 200. The control apparatus 110 is, for example, a vehicle-mounted apparatus in the vehicle 100. The vehicle-mounted apparatus is, for example, an ECU (electronic control unit), a car navigation system, or an ETC (electronic toll collection) vehicle-mounted apparatus. The control apparatus 110 may be a smartphone, a tablet terminal, a PC (personal computer), or the like. Alternatively, the projector apparatus 200 may include the control apparatus 110. The control apparatus 110 includes, for example, a processor 111, a ROM (read-only memory) 112, a RAM (random-access memory) 113, an auxiliary storage 114, a communication interface 115, a display device 116, and an input device 117. A bus 118 or the like connects these components. The control apparatus 110 may include the camera 120. Note that the control apparatus 110 is an example of a projection management apparatus.

The processor 111 is a center portion of a computer that performs processes such as computations, control and the like required to operate the control apparatus 110, and performs various computations, processes, and the like. The processor 111 may be, for example, a CPU (central processing unit), an MPU (micro processing unit), an SoC (system on a chip), a DSP (digital signal processor), a GPU (graphics processing unit), an ASIC (application specific integrated circuit), a PLD (programmable logic device), an FPGA (field-programmable gate array), or the like. Alternatively, the processor 111 may be a combination of multiple components among these. The processor 111 may be one that further includes a hardware accelerator or the like in combination with these. The processor 111 controls each component in order to achieve various functions of the control apparatus 110, based on programs such as firmware, system software and application software and the like stored in the ROM 112, the auxiliary storage 114, or the like. The processor 111 executes after-mentioned processes, based on the programs. Note that some or all of the programs may be implemented in the circuit of the processor 111.

The ROM 112 and the RAM 113 are a main memory of the computer centered at the processor 111. The ROM 112 is a non-volatile memory used to read data in a dedicated manner. The ROM 112 stores, for example, firmware and the like among the programs described above. The ROM 112 also stores data and the like that the processor 111 uses for performing various processes.

The RAM 113 is a memory used to read and write data. The RAM 113 is used as a work area and the like for storing data that the processor 111 temporarily uses for performing various processes. Typically, the RAM 113 is a volatile memory.

The auxiliary storage 114 is an auxiliary storage of the computer centered at the processor 111. The auxiliary storage 114 is, for example, an EEPROM (electric erasable programmable read-only memory), an HDD (hard disk drive), a flash memory, or the like. The auxiliary storage 114 stores, for example, the system software, the application software, and the like among the programs described above. The auxiliary storage 114 stores data that the processor 111 uses for performing various processes, data generated by the processes in the processor 111, various setting values, and the like.

The communication interface 115 is an interface for allowing the control apparatus 110 to communicate with another apparatus. The communication may be wireless communication or wired communication. The wireless communication may be wireless communication and wired communication in a mixed manner.

The display device 116 displays a screen for notifying various types of information to an operator or the like of the vehicle 100 or the control apparatus 110. The display device 116 is, for example, a display such as a liquid crystal display or an organic EL (electro-luminescence) display.

The input device 117 accepts an operation by the operator of the vehicle 100 or the control apparatus 110. The input device 117 is, for example, a keyboard, a keypad, a touch pad, a controller, or the like. The input device 117 may be a device for audio input. A touch panel may be used as the display device 116 and the input device 117. In this case, a display panel included in the touch panel functions as the display device 116. A touch-input type pointing device included in the touch panel functions as the input device 117.

The bus 118 includes a control bus, an address bus, a data bus, and the like, and transfers signals exchanged between the components of the control apparatus 110.

The camera 120 is installed in the vehicle 100. In the vehicle 100, a plurality of cameras 120 may be installed. The camera 120 takes an image of the inside of the cabin of the vehicle 100. The camera 120 outputs taken image data. Note that a moving image is a type of the image.

The seat 130 is a chair in which a person in the vehicle 100 is seated. The vehicle 100 includes for example, a seat 130 for a driver, a seat 130 as a passenger seat, and a seat 130 as a rear seat. The seat 130 may be transformable. The transformation of the seat 130 includes, for example, reclining, front-rear slide, and change in seat surface height. Note that the seat 130 may include a sensor that detects that a person is seated in the seat 130.

The control apparatus 110 can obtain seat information. The seat information is information that indicates transformation state of the seat 130. The transformation state includes, for example, the reclining angle of the seat 130, the front-rear position of the seat 130, and the height of the seat surface of the seat 130. The control apparatus 110 obtains seat information from an apparatus that controls the seat 130. The apparatus that controls the seat 130 can detect the transformation state of the seat 130. The apparatus that controls the seat 130 may be capable of controlling the seat 130 to transform the seat 130. The apparatus that controls the seat 130 is, for example, a vehicle-mounted apparatus in the vehicle 100. Alternatively, the seat 130 may include an apparatus that controls the seat 130. Alternatively, the control apparatus 110 may be an apparatus that controls the seat 130. In this case, the processor 111 of the control apparatus 110 obtains the seat information by detecting the transformation state of the seat, for example.

Alternatively, the processor 111 of the control apparatus 110 may obtain the seat information by detecting the transformation state of the seat according to another method. The processor 111 detects the transformation state of the seat 130 by image analysis of an image taken by the camera 120, for example. In the image, the seat 130 is imaged.

The projector apparatus 200 is also called a projector. The projector apparatus 200 is an apparatus that projects an image on a projection object by projecting light. In the embodiment, the projection object is at any site in the cabin of the vehicle 100. Examples of a projection destination of the image include the ceiling, a wall, a door, and the floor, the back of the backrest of the seat 130, window glass, the dashboard, and the like in the cabin of the vehicle 100. For example, the projector apparatus 200 is placed in the vehicle 100 and is used. For example, the projector apparatus 200 is installed in the vehicle 100. The projector apparatus 200 may be preliminarily equipped in the vehicle 100. For example, the projector apparatus 200 is installed between a seat and a seat that are rear seats.

The projector apparatus 200 includes, for example, a processor 201, a ROM 202, a RAM 203, an auxiliary storage 204, a communication interface 205, and a projector device 206. A bus 207 or the like connects these components.

The processor 201 is a center portion of a computer that performs processes, such as computations and control, required to operate the projector apparatus 200, and performs various computations, processes, and the like. The processor 201 is, for example, a CPU, an MPU, an SoC, a DSP, a GPU, an ASIC, a PLD, an FPGA, or the like. Alternatively, the processor 201 may be a combination of multiple components among these. The processor 201 may be one that further includes a hardware accelerator or the like in combination with these. The processor 201 controls each component in order to achieve various functions of the projector apparatus 200, based on programs, such as of firmware, system software, and application software, stored in the ROM 202, the auxiliary storage 204, or the like. The processor 201 executes after-mentioned processes, based on the programs. Note that some or all of the programs may be implemented in the circuit of the processor 201.

The ROM 202 and the RAM 203 are a main memory of the computer centered at the processor 201. The ROM 202 is a non-volatile memory used to read data in a dedicated manner. The ROM 202 stores, for example, firmware and the like among the programs described above. The ROM 202 also stores data and the like that the processor 201 uses for performing various processes.

The RAM 203 is a memory used to read and write data. The RAM 203 is used as a work area and the like for storing data that the processor 201 temporarily uses for performing various processes. Typically, the RAM 203 is a volatile memory.

The auxiliary storage 204 is an auxiliary storage of the computer centered at the processor 201. The auxiliary storage 204 is, for example, an EEPROM, an HDD, a flash memory, or the like. The auxiliary storage 204 stores, for example, the system software, the application software, and the like among the programs described above. The auxiliary storage 204 stores data that the processor 201 uses for performing various processes, data generated by the processes in the processor 201, various setting values, and the like.

The communication interface 205 is an interface for allowing the projector apparatus 200 to communicate with another apparatus. The communication may be wireless communication or wired communication. The communication may be wireless communication and wired communication in a mixed manner.

The projector device 206 is a display apparatus that projects an image on a projection object by projecting light. The projector device 206 includes, for example, a light source and a lens. The light source emits light. The lens projects light onto the projection object.

The bus 207 includes a control bus, an address bus, a data bus, and the like, and transfers signals exchanged between the components of the projector apparatus 200.

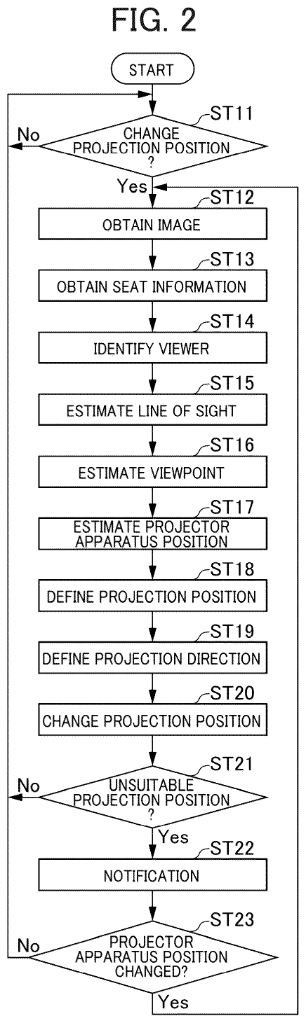

Hereinafter, the operation of the projector system 1 according to the embodiment is described with reference to FIG. 2 and the like. Note that the content of the processes in after-mentioned description of the operation is an example. Various processes that can obtain a similar result can be appropriately used. FIG. 2 is a flowchart showing an example of processes by the processor 111 of the control apparatus 110. The processor 111 executes processes in FIG. 2, based on, for example, the program stored in the ROM 112, the auxiliary storage 114, or the like.

In step ST11 in FIG. 2, the processor 111 of the control apparatus 110 determines whether to execute a change process or not. The change process is a process for changing the projection position of the image by the projector apparatus 200 to the optimal position based on the direction of eyes of the viewer. Note that at the time of executing the change process, it does not matter whether the projector apparatus 200 is projecting light or not. At the time of executing the change process, it does not matter whether the projector apparatus 200 is projecting the image or not. Here, the viewer is a person who views the image among people in the vehicle 100. For example, upon an operation input for an instruction for performing the change process through the input device 117, the processor 111 determines execution of the change process. If the processor 111 does not determine execution of the change process, it determines No in step ST11, and repeats the process in step ST11. On the other hand, if the processor 111 determines execution of the change process, it determines Yes in step ST11 and proceeds the processing to step ST12.

In step ST12, the processor 111 obtains an image taken by imaging the inside of the vehicle 100 through the camera 120. Note that the processor 111 may obtain a plurality of the images.

As described above, the processor 111 functions as an example of an image obtainer that obtains the image taken by imaging the inside of the cabin of the vehicle, by performing the process in step ST12.

In step ST13, the processor 111 obtains seat information.

As described above, the processor 111 functions as an example of a seat information obtainer that obtains the seat information that indicates the state of the seat, by performing step ST13.

In step ST14, the processor 111 identifies the seat 130 in which the viewer is seated. The processor 111 identifies the seat 130 in which the viewer is seated, by image analysis of the image taken in step ST12, for example. Note that if there are a plurality of viewers, the processor 111 identifies in which seats 130 the respective viewers are seated.

Alternatively, the processor 111 may identify in which seats 130 the respective viewers are seated, using sensors included in the seats 130.

In step ST15, the processor 111 estimates the line of sight of the viewer using at least one of the image obtained in step ST12, and the seat information obtained in step ST13. The processor 111 estimates the direction of the line of sight by, for example, any method among the following (A1) to (A4).
(A1) The processor 111 estimates the position of the eyes of the viewer, by image analysis of the image obtained in step ST12. In a case where it is difficult to directly estimate the position of the eyes, such as a case where the eyes of the viewer are not imaged, or a case where the accuracy of the image analysis is low, the processor 111 may estimate the position of the head of the viewer. The processor 111 then estimates the position of the eyes from the position of the head. The processor 111 identifies the angle of the backrest of the seat 130 in which the viewer is seated, using the seat information obtained in step ST13. The processor 111 adopts a vector that has a starting point at the estimated position of the eyes of the viewer and is in parallel to the normal direction of the backrest, as a line-of-sight vector that indicates the line of sight of the viewer.
(A2) The processor 111 estimates the position of the eyes of the viewer, by image analysis of the image obtained in step ST12. The processor 111 then identifies the direction in which the eyes are looking, by the image analysis of the image. The processor 111 adopts a vector that has a starting point at the estimated position of the eyes of the viewer and indicates the direction concerned, as a line-of-sight vector that indicates the line of sight of the viewer.
(A3) The processor 111 estimates the position of the eyes of the viewer, by image analysis of the image obtained in step ST12. The processor 111 then identifies the angle of the backrest of the seat 130 in which the viewer is seated, by image analysis of the image taken in step ST12. The processor 111 adopts a vector that has a starting point at the estimated position of the eyes of the viewer and is in parallel to the normal direction of the backrest, as a line-of-sight vector that indicates the line of sight of the viewer.
(A4) The processor 111 estimates the position of the eyes of the viewer, using the seat information obtained in step ST13. The processor 111 estimates the position of the eyes using, for example, information showing the height of the eyes of the viewer. The information showing the height of the eyes of the viewer is, for example, the sitting height, the height from the floor to the eyes in an upright standing state, or the height from the seat surface to the eyes in a seating state with the upper body being upright. Note that the information showing the height of the eyes the viewers is preset for the viewer, an administrator of the control apparatus 110, or the like. The auxiliary storage 114 stores the information showing the height of the eyes. Alternatively, the processor 111 may estimate the height of the eyes of the viewer using information showing the height of the eyes of a typical person. The processor 111 identifies the angle of the backrest of the seat 130 in which the viewer is seated, using the seat information obtained in step ST13. The processor 111 adopts a vector that has a starting point at the estimated position of the eyes of the viewer and is in parallel to the normal direction of the backrest, as a line-of-sight vector that indicates the line of sight of the viewer.

Note that in the case where there are a plurality of viewers, the processor 111 estimates the line of sight, with any one viewer being adopted as a target. Alternatively, the processor 111 estimates the viewing distances, with all the viewers being adopted as targets. Alternatively, the processor 111 may calculate the average of lines of sight of the plurality of viewers. The processor 111 calculates an average vector of line-of-sight vectors of the plurality of viewers. The average vector indicates the average of the lines of sight of the plurality of viewers.

As described above, the processor 111 functions as an example of a line-of-sight estimator that estimates the line of sight of the person in the cabin of the vehicle 100, by performing the process in step ST15.

In step ST16, the processor 111 estimates the viewpoint of the viewer using the line of sight estimated in step ST15. The processor 111 adopts, as the viewpoint, a position to which the line of sight estimated in step ST15 indicates, for example. That is, the processor 111 adopts, as the viewpoint, the extended line along which the line-of-sight vector estimated in step ST15 is extended in the direction of the line-of-sight vector intersects with an object at the first time, for example. The object and the viewpoint are at any point in the vehicle 100.

Note that in the case where there are a plurality of viewers, the processor 111 estimates the viewpoint, with any one viewer being adopted as a target. Alternatively, the processor 111 estimates the viewpoints, with all the viewers being adopted as targets. Alternatively, the processor 111 estimates the viewpoint using the average of lines of sight of the plurality of viewers.

In step ST17, the processor 111 estimates the position of the projector apparatus 200, by image analysis of the image obtained in step ST12. Note that it is assumed that in the image, the projector apparatus 200 is imaged. The processor 111 may estimate the position of the lens included in the projector apparatus 200, as the position of the projector apparatus 200. Note that the image used for the image analysis in step ST15, and the image used for the image analysis in step ST16 may be different images or the same image.

As described above, the processor 111 functions as an example of a position estimator that estimates the position of the projector apparatus that is installed in the vehicle and projects the image in the cabin, by performing the process in step ST17.

In step ST18, the processor 111 defines the projection position of the projector apparatus 200. The processor 111 assumes the viewpoint estimated in step ST16 as the center of the projection position. In the case where the plurality of viewpoints are estimated in step ST16, the processor 111 assumes, for example, the viewpoint of any one person as the center of the projection position. Alternatively, in the case where the plurality of viewpoints are estimated in step ST16, the processor 111 assumes the average position of these viewpoints as the center of the projection position.

In step ST19, the processor 111 defines a direction in which the projector apparatus 200 projects light, i.e., a direction in which the projector apparatus 200 projects the image (hereinafter called “projection direction”), using the position estimated in step ST17 and the projection position defined in step ST18. Note that the projection direction defined in step ST19 is hereinafter called “defined direction”. The processor 111 assumes, as the defined direction, for example, the direction from the position estimated in step ST17 to the projection position.

As described above, the processor 111 functions as an example of a definer that defines the projection direction of the projector apparatus using the line of sight and the position of the projector apparatus, by performing step ST19.

In step ST20, the processor 111 instructs the projector apparatus 200, via the communication interface 205, to change the projection direction of the projector apparatus 200. The processor 201 of the projector apparatus 200 controls the projector device 206 to change the projection direction to the defined direction, based on the instruction. Note that if the defined direction is out of a range within which the projector apparatus 200 can perform projection, the processor 111 may change the projection direction of the projector apparatus 200 to the direction closest to the defined direction within the range that allows projection.

As described above, the processor 111 functions as, for example, a changer that controls the projector apparatus to change the projection direction of the projector apparatus to the projection direction defined by the definer, by performing the process in step ST20.

In step ST21, the processor 111 determines whether there is an event unsuitable for projecting the image by the projector apparatus 200 or not. The processor 111 performs the determination by, for example, image analysis of the image obtained from the camera 120. As examples of events unsuitable for projecting the image, (B1) and (B2) are described as follows.
(B1) The defined direction is unsuitable as the projection position of the projector apparatus 200.
(B2) The installation position of the projector apparatus 200 is unstable.

As examples of (B1), (B1-1) to (B1-3) are described as follows.
(B1-1) The irregularity of the projection range is a predetermined degree or higher. The projection range is a range in which the projector apparatus 200 projects light.
(B1-2) An obstacle intervenes between an object on which the projector apparatus 200 projects light, and this projector apparatus 200.
(B1-3) The defined direction is out of the range in which the projector apparatus 200 can perform projection.

As described above, the processor 111 functions as an example of a determiner that determines that there is an event unsuitable for projecting the image by the projector apparatus, by performing the process in step ST21.

If the processor 111 does not determine that there is an event unsuitable for projecting the image by the projector apparatus 200, it determines No in step ST21, and returns the processing to step ST11. On the other hand, if the processor 111 determines that there is an event unsuitable for projecting the image by the projector apparatus 200, it determines Yes in step ST21, and proceeds the processing to step ST22.

In step ST22, the processor 111 notifies the person in the vehicle 100 of presence of an event unsuitable for projecting the image by the projector apparatus 200, of the details of the event, and of a method of solving the event. The processor 111 performs this notification, by causing the display device 116 to display an image indicating the notification details, for example. The processor 111 may perform the notification by outputting audio indicating the notification details through a speaker.

The method of solving the event is, for example, to change the installation position of the projector apparatus 200. The method of solving the event may include proposal of the installation position of the projector apparatus 200 that can solve the event. The processor 111 proposes the predefined installation position. Alternatively, the processor 111 may define the installation position by searching for the installation position that allows the event to be solved using, for example, the image analysis of the image obtained from the camera 120.

The person in the vehicle 100 sees the notification, and can change the position of the projector apparatus 200.

As described above, the processor 111 functions as an example of a proposer that proposes the installation position of the projector apparatus 200 by performing the process in step ST22 if it is determined that there is an unsuitable event by the determiner.

In step ST23, the processor 111 determines whether the installation position of the projector apparatus 200 has been changed or not. The processor 111 determines that the installation position of the projector apparatus 200 has been changed, using the image analysis of the image obtained from the camera 120, for example. For example, if the installation position of the projector apparatus 200 has not been changed within a predetermined time period, the processor 111 assumes that a timeout has occurred, and determines that the installation position of the projector apparatus 200 has not been changed. For example, if an operation indicating that the installation position of the projector apparatus 200 is not to be changed is performed through the input device 117, the processor 111 determines that the installation position of the projector apparatus 200 has not been changed. If the processor 111 determines that the installation position of the projector apparatus 200 has been changed, it determines Yes in step ST23, and returns the processing to step ST12. On the other hand, if the processor 111 determines that the installation position of the projector apparatus 200 has not been changed, it determines No in step ST23, and returns the processing to step ST11.

The control apparatus 110 estimates the line of sight of the viewer in the cabin of the vehicle 100. The control apparatus 110 in the embodiment estimates the position of the projector apparatus 200. The control apparatus 110 in the embodiment determines the projection direction of the projector apparatus 200 using the estimated line of sight and the estimated position of the projector apparatus 200. As described above, the control apparatus 110 in the embodiment can estimate the position of the projector apparatus 200. Accordingly, even if the position of the projector apparatus 200 is indefinite, this control apparatus can define the projection direction and the projection position that are easily visible to the viewer.

The control apparatus 110 in the embodiment changes the projection direction of the projector apparatus 200 to the defined projection direction. Accordingly, the viewer or the like is not required to manually change the projection direction of the projector apparatus 200.

The control apparatus 110 in the embodiment estimates the line of sight of the viewer using the state of the seat 130. Accordingly, the control apparatus 110 in the embodiment has an improved accuracy of estimating the line of sight of the viewer.

The control apparatus 110 in the embodiment estimates the line of sight of the viewer using the image taken by imaging the inside of the cabin of the vehicle 100. The control apparatus 110 in the embodiment can estimate the line of sight of the viewer at a lower cost using the image than use of various sensors.

The control apparatus 110 in the embodiment estimates the position of the projector apparatus 200 using the image taken by imaging the inside of the cabin of the vehicle 100. The control apparatus 110 in the embodiment can estimate the position of the projector apparatus 200 at a lower cost using the image than use of various sensors.

If there is an event unsuitable for projecting the image by the projector apparatus 200, the control apparatus 110 in the embodiment proposes the installation position of the projector apparatus 200. Accordingly, the control apparatus 110 in the embodiment can reinstall the projector apparatus 200 to a more suitable position.

The control apparatus 110 in the embodiment estimates the lines of sight of a plurality of viewers. The control apparatus 110 in the embodiment then defines the projection direction of the projector apparatus 200 using the estimated lines of sight of the plurality of viewers. Accordingly, in the case with the plurality of viewers, the control apparatus 110 in the embodiment may define the projection direction and the projection position easily visible to the viewer.

The embodiment described above can be modified as follows. Changing of the projection direction of the projector apparatus 200 may be manually performed. In this case, the processor 111 of the control apparatus 110 notifies the person in the vehicle 100 of the defined direction. The person can change the projection direction of the projector apparatus 200 to the defined direction in accordance with the notification.

The processor 111 of the control apparatus 110 may estimate the position of the projector apparatus 200 using a method other than the image analysis. For example, the processor 111 estimates the position of the projector apparatus 200 using sensing results by various sensors, such as an infrared sensor, a radar, or a LIDAR (light detection and ranging). For example, the processor 111 estimates the position of the projector apparatus 200 using the communication intensity of communication by the projector apparatus 200.

The processor 111 of the control apparatus 110 may estimate the direction of eyes of the viewer using sensing results of various sensors, such as an infrared sensor, a radar, or a LIDAR.

The processor 111 of the control apparatus 110 may identify the angle of the backrest of the seat 130 using sensing results of various sensors, such as an infrared sensor, a radar, or a LIDAR.

The projector apparatus 200 may have a moving function. In this case, the processor 111 of the control apparatus 110 may move the projector apparatus 200 instead of issuing a notification or in addition to issuing a notification in step ST22. The movement destination of the projector apparatus 200 is an installation position of the projector apparatus 200 that can solve an event unsuitable for projecting the image by the projector apparatus 200. The processor 111 instructs the projector apparatus 200 to move to the installation position, through the communication interface 205. The processor 201 of the projector apparatus 200 moves the projector apparatus 200 to the installation position, based on the instruction.

Each apparatus in the embodiment may be made up of a plurality of apparatuses.

The processor 111 and the processor 201 may be achieved by hardware configurations of circuits performing some or all of the processes implemented by the program in the aforementioned embodiment.

The program that implements the processes of the embodiment is transferred, for example, in a state of being stored in a non-transitory computer readable storage medium in the apparatus. However, the apparatus may be transferred in a state of not storing the program. The program may then be separately transferred and be written into the apparatus. The transfer of the program in this case can be achieved by recording it in a removable non-transitory computer readable storage medium, or by downloading it via a network, such as the Internet or a LAN (local area network).

The embodiment of the present invention is thus described above, but is described as an example, and does not limit the scope of the present invention. The embodiment of the present invention can be implemented in various aspects in a range without departing from the gist of the present invention.

### EXPLANATION OF REFERENCE NUMERALS

1 Projector system
100 Vehicle
110 Control apparatus
111, 201 Processor
112, 202 ROM
113, 203 RAM
114, 204 Auxiliary storage
115, 205 Communication interface
116 Display device
117 Input device
118, 207 Bus
120 Camera
130 Seat
200 Projector apparatus
206 Projector device

What is claimed is:

1. A projection management apparatus, comprising:
a line-of-sight estimator configured to estimate a line of sight of a person in a cabin of a vehicle;
a position estimator configured to estimate a position of a projector apparatus that is installed in the vehicle and projects an image in the cabin; and
a definer configured to define a projection direction of the projector apparatus using the line of sight and the position.

2. The projection management apparatus according to claim 1, further comprising a changer configured to control the projector apparatus to change the projection direction of the projector apparatus to the projection direction defined by the definer.

3. The projection management apparatus according to claim 1, further comprising
a seat information obtainer configured to obtain seat information that indicates a state of a seat,
wherein the line-of-sight estimator estimates the line of sight using the seat information.

4. The projection management apparatus according to claim 1, further comprising
an image obtainer configured to obtain an image in which an inside of the cabin is taken,
wherein the line-of-sight estimator estimates the line of sight using the image obtained by the image obtainer.

5. The projection management apparatus according to claim 1, further comprising
an image obtainer configured to obtain an image in which an inside of the cabin is taken,
wherein the position estimator estimates the position using the image obtained by the image obtainer.

6. The projection management apparatus according to claim 1, further comprising:
a determiner configured to determine that an event unsuitable for projecting the image by the projector apparatus is present; and
a proposer configured to propose an installation position of the projector apparatus if it is determined that the event unsuitable is present by the determiner.

7. The projection management apparatus according to claim 1, wherein
the person includes a plurality of people in the cabin,
the line-of-sight estimator estimates the lines of sight of the plurality of people in the cabin, and
the definer defines the projection direction using the lines of sight of the plurality of people in the cabin.

8. A non-transitory computer readable storage medium storing a program causing a processor included in a projection management apparatus to function as:
a line-of-sight estimator configured to estimate a line of sight of a person in a cabin of a vehicle;
a position estimator configured to estimate a position of a projector apparatus that is installed in the vehicle and projects an image in the cabin; and
a definer configured to define a projection direction of the projector apparatus using the line of sight and the position.
